(19) United States
(12) Patent Application Publication
(10) Pub. No.: US 2013/0167735 A1
(43) Pub. Date: Jul. 4, 2013

(54) Combination Grill Press and Thermometer

(71) Applicant: Gary Guarnotta, Santee, CA (US)

(72) Inventor: Gary Guarnotta, Santee, CA (US)

(21) Appl. No.: 13/535,138

(22) Filed: Jun. 27, 2012

Related U.S. Application Data
(60) Provisional application No. 61/583,003, filed on Jan. 4, 2012.

(51) Int. Cl. A47J 37/06

(52) U.S. Cl. 99/343

(57) ABSTRACT

A Combination Grill Press and Thermometer. The device provides a user with dual functionality—that of a conventional grill press as well as the ability to detect and display the temperature of the item being grilled. The device is preferably constructed to have a solid metal base portion that may or may not have a plurality of grooves embossed in its bottom face. In addition, the device has one or more temperature probes extending past the bottom face. The probes are configured to actually protrude into a piece of meat when the device is pressed down onto it. Finally, there is a temperature display element for each temperature probe, with these one or more display elements being viewable from atop the base portion.

This application is filed within one year of, and claims priority to Provisional Application Ser. No. 61/583,003, filed Jan. 4, 2012.

### BACKGROUND OF THE INVENTION

1. Field of the Invention

This invention relates generally to cooking accessories and, more specifically, to a Combination Grill Press and Thermometer.

2. Description of Related Art

One of the most prevalent problems facing home chefs is determining when a piece of meat has achieved the proper level of doneness. The most common approaches that people use to assess whether or not a particular piece of meat is done or not include: poking it to determine how soft or firm the meat has become; using a timer to govern how long the meat stays on the grill; and just using the visual appearance of the meat to signal that it has reached its appropriate doneness.

It is well-known that the only accurate way to test a piece of meat for doneness is to check the temperature inside of the piece. A wide variety of conventional and electronic meat thermometers are available, and can be purchased in any corner grocery store. An yet, it is rare to actually see a home chef actually using a meat thermometer while grilling (or stove-top frying). It is unclear why this is the case, but perhaps it has something to do with either safety (not wanting to handle a hot thermometer on the grill), or simply a case of complacency (it is too much trouble to seek out the grill thermometer and then test each individual piece of meat on a periodic basis).

The solution described herein is to combine a meat thermometer with a device known as a grill press. A conventional grill press is a metallic “iron” that the chef will press down onto a piece of meat or burger while it is cooking. The press can also have grooves cut into it that will create marks in the surface of the meat or burger as a result of being pressed. It is believed that pressing the meat (in addition to marking and flattening it) will also force out some of the grease and fat, thereby resulting in a leaner and more flavorful burger or piece of meat. While smooth and grooved grill presses are well known, never before have the two been combined into a single device that can then perform two functions.

A search for prior art references revealed Spicer, Muskat, Hill, Kwoh, Coffman and Stevens. Of these, only Stevens has any relationship with Applicant's device. W. W. Stevens et al., U.S. Pat. No. 2,040,676 describes a “Cooking Utensil” that has an integrated thermometer for determining the temperature of the device when it has been placed on a grill or stove. The Stevens thermometer is not capable to detecting the temperature of a meat upon which the device is placed because the Stevens device does not probe into the meat, nor does it even sense the temperature of the face of the piece of meat.

R. A. Coffman is an “apparatus for cooking meat and the like.” It, like the Stevens device is designed to heat a piece of meat upon which it is placed. While Stevens provides heat that is obtained by pre-heating the device on the grill or stove, the Coffman device actually has built-in electric heating element(s). Coffman does not include any thermometer for sampling the temperature within the meat.

E. T. Y. Kwoh describes a “reversible multiple cooking oven, steamer, grill and griddle.” While the Kwoh device does include an integral thermometer, like Stevens, the Kwoh thermometer does not display the meat temperature. The Kwoh device has a hollow chamber formed beneath the lid—it is this region that is temperature-sampled and displayed, and not the piece of meat.

Hill and Muskat et al., U.S. Pat. Nos. 7,586,067 and 7,703,387, respectively, both disclose modified grill presses. Neither Hill nor Muskat, however, include any sort of thermometer. Finally, Spicer, U.S. Pat. No. 5,712,466 for the “perfect steak device” does include temperature probes for determining meat temperature. Rather than being a grill press, the Spicer device is actually a temperature-sampling cooking lid. It is place atop food that is cooking on a cooking surface—the device uses sampled temperature to control the heat of the cooking device in response to the Spicer device's sensing of the meat's temperature.

In order to obtain the benefits of having a handy meat thermometer as well as being to press the meat to release excess fat and grease, what is needed is a combination grill press and meat thermometer, such as is described herein below.

### SUMMARY OF THE INVENTION

In light of the aforementioned problems associated with the prior devices and combinations, it is an object of the present invention to provide an Combination Grill Press and Thermometer. The device should provide a user with dual functionality—that of a conventional grill press as well as the ability to detect and display the temperature of the item being grilled. The device should preferably be constructed to have a solid metal base portion that may or may not have a plurality of grooves embossed in its bottom face. In addition, the device should also have one or more temperature probes extending past the bottom face. The probes should be configured to actually protrude into a piece of meat when the device is pressed down onto it. Finally, there should be a temperature display element for each temperature probe, with these one or more display elements being viewable from atop the base portion.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the combination grill press and thermometer of the present invention;

FIG. 2 is a bottom perspective view of the device of FIG. 1;

FIG. 3 is a partially cutaway side view of the device of FIGS. 1 and 2;

FIG. 4 is a partially cutaway side view of an alternate embodiment of the device of the present invention; and

FIG. 5 is a partially cutaway side view of yet another alternate embodiment of the device of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Combination Grill Press and Thermometer.

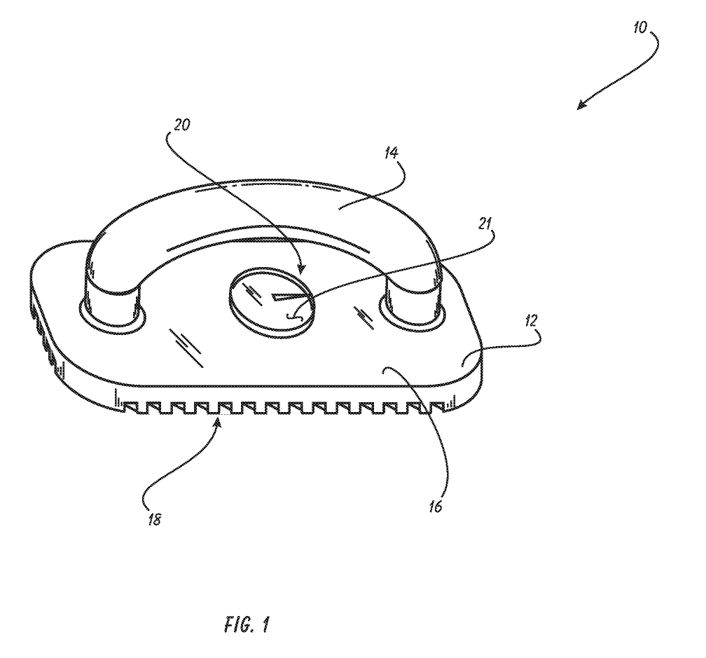

The present invention can best be understood by initial consideration of FIG. 1. FIG. 1 is a perspective view of a preferred embodiment of the combination grill press and thermometer 10 of the present invention. The device 10 is fairly simple in design, and is intended to be easily handled and stored. An optimal size might be approximately twice the surface area of a typical hamburger. There is a base 12, defined by a top face 16 and a bottom face 18. A temperature display 20 is provided on the base 12, typically dispersed on the top face 16 in a convenient location for viewing.

In its preferred form, the base 12 is made from a solid block of metal, such as aluminum or steel. A solid piece of metal will enhance the heat transfer capability of the base 12, and will provide a durable, solid structure that the chef can easily use to press down on burgers, steaks and other pieces of meat. The handle 14 should be thermally insulated from the base 12 to protect the user from burning his or her hand. It could be made from a solid insulating material (e.g. wood, plastic, etc.), could comprise an insulating outer layer over a conducting center structural element, or could simply be thermally isolated from the base 12 by spacers or grommets at the attachment points of the handle 14.

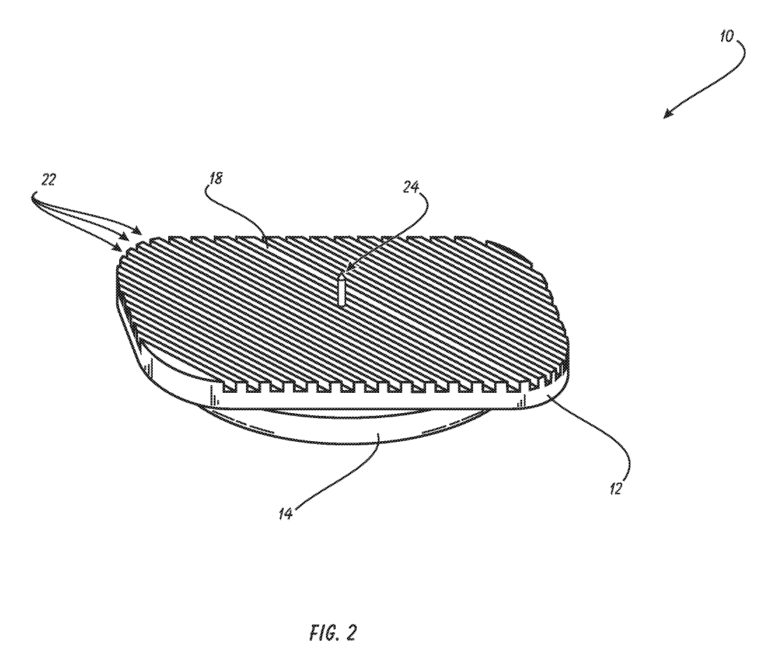

The temperature display 20 depicted here is conceptual in form. Here, the display 20 is an analog, dial-type display that is common to conventional meat thermometers. The face 21 of the display 20 would be labeled with temperature gradations to indicate that temperature detected by the temperature probe (see FIG. 2). Additionally, the face 21 may display recommended temperatures for a variety of donenesses of meat (e.g. medium rare, well-done, etc.). In alternate, non-depicted embodiments, the temperature display 20 could be electronic (LED or LCD), and would display the sensed temperature digitally. Of course, in such versions, the temperature probe (see FIG. 2) will include a thermocouple or other electronic temperature-sensing element. FIG. 2 provides additional detail regarding this novel device.

FIG. 2 is a bottom perspective view of the device 10 of FIG. 1. The bottom face 18 of the device 10 may or may not have a plurality of grooves 22 cut into it. The grooves 22 are intended to imprint a pattern onto the top of the burger or piece of meat when the press is forced onto it. Furthermore, the grooves 22 may channel fat and grease to the sides of the meat when pressed down. In other versions, the face 18 may be smooth, or may even have other designs or indicia cut into it (e.g. a person's initials or name, etc.). This feature is not intended to contribute to the functioning of the temperature-sensing capability of the device 10.

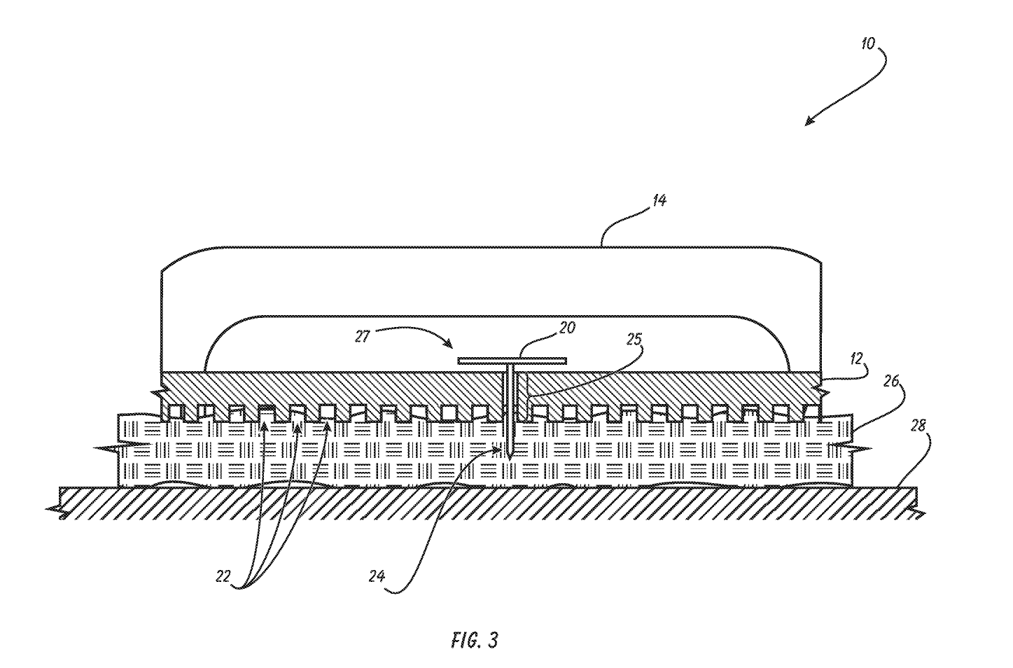

As can be seen, a temperature probe element 24 protrudes beyond the face 18 of the device 10. The probe element 24 is operatively connected to the temperature display [20] (brackets [ ] are intended to indicate that the enumerated element is depicted in another drawing figure in the instant Specification). As should be apparent, when the bottom face 18 is pressed down onto the burger or piece of meat, the probe element 24 will protrude into the burger/meat so as to provide a temperature reading of the internal volume of the burger/meat, rather than just the outer layer. The probe 24 may function by thermocouple, thermistors, strain gage, integrated circuit, or just conventional bi-metallic (like any budget meat thermometer). FIG. 3 continues to provide additional detail regarding this invention.

FIG. 3 is a partially cutaway side view of the device 10 of FIGS. 1 and 2. A piece of meat 26 is being cooked upon a grill 28. At an appropriate time, the user has pressed the device 10 down onto the top surface of the piece of meat 26. The grooves 22 are being pressed into the meat 26, and the probe element 24 has been driven down into the center region of the thickness of the piece of meat 26. As should be apparent, the temperature display 20 will display the temperature that the probe element 24 is sensing from the center region of the meat 26.

Here, the probe element 24 and display 20 are a single assembly. The probe element 24 extends through a bore 25 formed in the base 12 of the device 10. The stem of the meat thermometer 27 extends between the display head 20 and the probe element 24 (through the bore 25). The thermometer 27 should be removable from the bore 25 in order to permit the safe cleaning and replacement of the thermometer 27. The interior surface of the bore (and exterior surface of the stem) may be threaded in order to allow for the secure attachment and detachment of the thermometer 27 to the base 12. Furthermore, it might be desirable that the depth of the probe 24 be adjustable, so that it can be raised or lowered in order to cooperate with the thickness of the particular burger/piece of meat to be positioned in the center of the item.

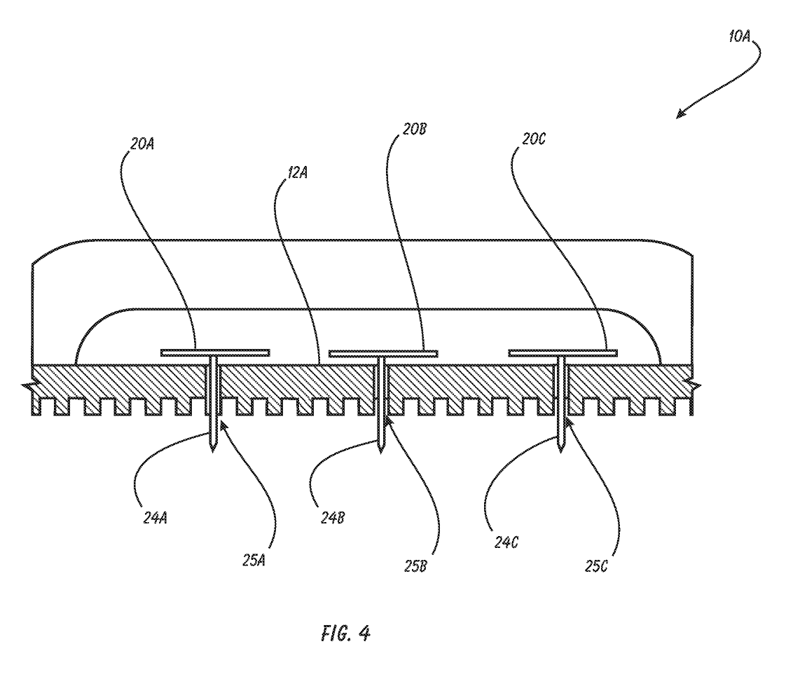

Many chefs use grill presses for their grilling, but are required to assess the doneness of the cooking meat by some other means. Using the device 10, now chefs can press the meat and test for doneness in one simple step. The handle 14 makes the device 10 convenient and safe for use on even the hottest grill. FIG. 4 depicts an expansion on the basic device.

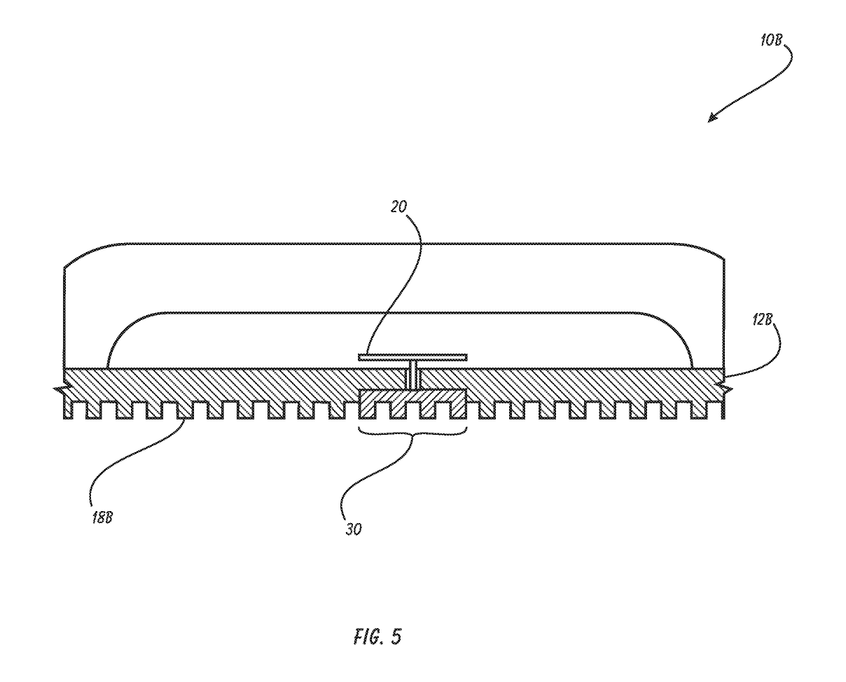

FIG. 4 is a partially cutaway side view of an alternate embodiment of the device 10A of the present invention. In certain cases, the chef may wish to sample the meat temperature at more than one location (or on more than a single piece of meat or burger) at one time. This alternate design 10A will provide such functionality. Essentially, the base 12A has more than one bore (e.g. 25A-25C) formed through it in order to accept more than one temperature probe (24A, 24B, 24C), such that the meat temperature is displayed at several different points within the meat at the plurality of temperature displays (20A-20C). This could be useful for large pieces of meat, or for commercial-style cooking/grilling operations where a large quantity of meat is placed on the grill/griddle. In cases where the base 12A is quite large, it is possible that the raising and lowering of the device 10A onto and off of the meat will be operated by machinery, rather than by hand. Finally, turning to FIG. 5, we can examine yet another version of the present invention.

FIG. 5 is a partially cutaway side view of yet another alternate embodiment of the device 10B of the present invention. Here, the device 10B incorporates a temperature sensor that is integrated into the bottom face 18B of the base 12B. The temperature reading would not be from inside the piece of meat, but rather from the top surface. While this may not provide the most accurate information regarding the doneness at the center of the meat, it does allow for a reading to be taken without puncturing the meat (or fish). This could be of value in cases where puncturing the meat is not desirable. Furthermore, as should be apparent, the bottom face 18B of this device 10B will be much easier to clean.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A combination grill press and thermometer, comprising:
a base defined by a top face and a bottom face;
a handle extending upwardly from said base;
a temperature probe within said base and positioned to detect the temperature of objects in contact with said bottom face; and
a display element dispersed on said top face to display indicia responsive to a a temperature of an object in contact with said bottom face.

2. The combination of claim 1, wherein said base further comprises a bore formed therethrough; and
said temperature probe extends through said bore to protrude from said bottom face.

3. The combination of claim 2, wherein said temperature probe comprises a probe element terminating at its top side at said display element and at an opposing end at a tip, said tip extending through said bore to protrude beyond said bottom face.

4. The combination of claim 3, wherein said bottom face is further defined by a plurality of grooves formed therein.

5. The combination of claim 1, wherein said base is formed from a single piece of homogeneous material.

6. The combination of claim 5, wherein said base is greater than or equal to one-half inch in thickness.

7. The combination of claim 1, wherein said temperature probe is encased in said base, and a portion of said temperature probe forms said bottom surface.

8. The combination of claim 1, wherein said temperature probe is fixedly inserted into said bore without interface with biasing elements.

9. A cooking accessory, comprising:
a base defined by a top face and a bottom face;
an arched handle extending upwardly from said base at a pair of opposing ends of said handle;
one or more temperature probes within said base and positioned to detect the temperature of objects in contact with said bottom face; and
a display element dispersed on said top face to display indicia responsive to a a temperature of an object in contact with said bottom face.

10. The accessory of claim 9, wherein said base further comprises a bore formed therethrough; and
each said temperature probe extends through said bore to protrude from said bottom face.

11. The accessory of claim 10, wherein each said temperature probe is fixedly inserted into said bore devoid of interface with biasing elements.

12. The accessory of claim 11, wherein said bottom face is further defined by a plurality of grooves formed therein.

13. The accessory of claim 12, wherein said base is formed from a single piece of homogeneous material.

14. The accessory of claim 13, wherein said base is greater than or equal to one-half inch in thickness.

15. The accessory of claim 9, wherein each said temperature probe is encased in said base, and a portion of said temperature probe forms said bottom surface.

16. A cooking utensil, comprising:
a generally flat metal base defined by a top face and a bottom face and having an average thickness of at least one-half inch;
one or more temperature probes within said base and positioned to detect the temperature of objects in contact with said bottom face; and
a display element dispersed on said top face to display indicia responsive to a a temperature of an object in contact with said bottom face.

17. The combination of claim 16, wherein said bottom face is further defined by a plurality of grooves formed therein such that said bottom surface has a non-smooth texture.

18. The combination of claim 17, wherein each said temperature probe comprises a probe element terminating at its top side at said display element and at an opposing end at a tip, said tip extending through said bore to protrude beyond said bottom face.

19. The combination of claim 18, wherein each said temperature probe is fixedly inserted into said bore without interface with biasing elements.

20. The combination of claim 16, wherein said temperature probe is encased in said base, and a portion of said temperature probe forms said bottom surface.
